(19) United States
(12) Patent Application Publication
(10) Pub. No.: US 2025/0320006 A1
(43) Pub. Date: Oct. 16, 2025

(54) DRONES UTILIZED FOR CONSTRUCTION OPTIMIZATION

(71) Applicant: Idealab Studio, LLC, Pasadena, CA (US)

(72) Inventors: William Tod Gross, Pasadena, CA (US); Andrea Pedretti, Thousand Oaks, CA (US)

(21) Appl. No.: 19/176,683

(22) Filed: Apr. 11, 2025

Related U.S. Application Data
(60) Provisional application No. 63/632,990, filed on Apr. 11, 2024.

(51) Int. Cl. B64U 50/30; B64U 20/70; B64U 101/26; G05D 1/69; G05D 105/45; G05D 109/20; G06Q 50/08

(52) U.S. Cl. CPC B64U 50/30; B64U 20/70; G05D 1/69; G06Q 50/08; B64U 2101/26; G05D 2105/45; G05D 2109/20

(57) ABSTRACT

A construction drone system includes a first (service) drone and a second (power) drone that work in unison to perform construction tasks to build a building or to assist a construction crew building a building. The service drone assists the power drone, and the power drone performs the construction task (with one or more interchangeable tools) or assists the construction crew. The drones exclude battery packs and instead are tethered by power cables to motorized reels (e.g., on a bed of a truck). The service drone incudes a pulley over which the table to the power drone extends, preventing ground contact of the power cables. The drone system can be operated remotely by an operator.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57 and should be considered a part of this specification.

### BACKGROUND

### Field

The present disclosure relates broadly to a drone system for use in construction, and more particularly to a) drones who purely assist workers by taking tools or material to the worker and the worker performs the building in no predefined sequence, b) assisted construction where drones bring material to workers who perform the construction with the assistance of the drones in a defined construction plan and predefined sequence, and c) automated construction where drones that follow a given work plan.

### Description of the Related Art

Existing building projects typically consist of heavy trucks and large cranes for lifting and/or transporting heavy supplies on a construction site with the utilization of a building crew. The building crew usually involves several individuals, each performing one or more tasks, which can add to the cost and time of construction.

### SUMMARY

In accordance with one aspect of the disclosure, a drone system is provided for use in construction projects. The drone system includes drones that assist construction workers by taking tools or material to the worker. The construction worker performs the building tasks in no predefined sequence.

In accordance with another aspect of the disclosure, a drone system is provided for use in construction projects. The drone system performs assisted construction where the drones bring material to construction workers, who perform the construction with the assistance of the drones in a defined construction plan and predefined sequence.

In accordance with another aspect of the disclosure, a drone system is provided for use in construction projects. The drone system performs automated construction where the drones perform all construction tasks and follow a given work plan.

In accordance with one aspect of the disclosure, a drone system includes several drones working in unison with one another to execute a construction task assigned to the respective drone or the drones as a group. The drone system may be configured to operate autonomously to complete the designated task (e.g., building a house, building a building, etc.), the drones determining the tasks that need to be performed to complete the construction job, and the specific tool(s) needed for each task. The individual drone of a drone system can autonomously navigate to a supply truck and grab the designated tool required for the task. The supply truck is used to transport as well as to store the drone system (when not in use), the supply truck including the drones, drone hardwire cables, battery packs to power the drones via power cables, and tool attachments. They drone system can utilize a plurality of drones to facilitate building projects (e.g., construction, etc.) while reducing the number of people required for a building project. Furthermore, the drone system may be utilized as a replacement for construction machinery (e.g., cranes) reducing cost of the overall project and increasing efficiency. The drone system may be deployed in one or more building sites and operated remotely (e.g., wirelessly) by a remote operator. Furthermore, the present disclosure relates the use of the drone system with storage and one or more deployment truck(s) utilized for storing the drone system, tool attachments, and supplies. The deployment truck(s) may further be utilized to carry additional personnel to assist with the project and/or further carry additional drone systems, tool attachments, and supplies.

The drones of a drone system may travel to the supply truck when a new tool is further required for the continuation of a project (e.g., to perform another construction task). Furthermore, there may be one or more auxiliary trucks that are deployed (e.g., cycle) at the construction site, the auxiliary truck transporting personnel and/or supplies/materials for the building project. The drones of the drone system can further determine that an auxiliary truck has a supply that is required to continue the building project, the drone may travel to the location of the auxiliary truck, find the supply or material required and take it to the location on a project site as required.

In accordance with another aspect of the disclosure, a drone system may be utilized as a delivery system that supports a construction crew at a construction or project site. When a person working on a project site requires a specific tool or supply from a supply truck or auxiliary truck, the person can request such a tool or supply (e.g. wirelessly, via an earpiece) and the drone system determines where the tool or supply is located with respect to the project site location, obtains the item and delivers it to the person that requested the item. The drone system may be deployed in more than one project site (e.g., adjacent project sites), wherein the drones may travel from a first project site to a second project site obtaining tools and/or supplies that are required from personnel working on a project site.

In accordance with another aspect of the disclosure, a drone system may include multiple drones working in unison with all the drones deployed on a project site. The drone system may comprise a power drone and a service drone wherein the power drone may be the drone utilized for work done on the project site and the service drone is utilized for supporting the power drone. The drone system is not limited to specific number of power drones or service drones used; in fact, the drone system is scalable as required per project site. For example, the service drone may operate as a leverage point for a pulley system to assist in extending cabling (e.g., power cable) to the power drone (e.g., to supply power to the power drone), and advantageously without tangling the cabling during operation of the drones. The service drone may further be electrically connected to a supply truck (e.g., tethered to the supply truck via a power cable), wherein the supply truck supplies electricity to the service drone and to the power drone when electrically connected. The supply truck houses a set of spooled cables on a motorized reel wherein the motorized reel may be operated to increase or reduce the cable length that is deployed to the drones (e.g., to the service drone, to the power drone) to allow the drones to travel as needed in the project site (e.g., to pick up tools and/or material and deliver them where required in the project site). The utilization of the service drone and power drone are scalable (e.g., more than one power drone can be used) as needed for a particular task (e.g., carrying a beam) or to reach a particular location of the project site.

In accordance with another aspect of the disclosure, a drone system includes multiple drones (e.g., two drones) that are tethered to the supply truck and are powered via cabling extending to the drones from the supply truck. The drones can autonomously build the designated project while maintaining orderly cable management, preventing entanglements of the cables used. The drone system can determine the location of the drone deployed on the project site and traverse the project site without interference. Furthermore, the drone system may travel to a supply truck and/or auxiliary truck as needed to interchange tool attachments used by a drone of the drone system or obtain building supplies from the auxiliary truck. The drone system continuously manages the distance between the drones of the drone system and cable length as deployed from the motorized reel of the supply truck.

In some aspects, the techniques described herein relate to a construction drone system, including: a power drone operable to perform a construction task; a service drone operable to assist the power drone; a first motorized reel about which a first power cable is wound, an end of the first power cable connected to the power drone; a second motorized reel about which a second power cable is wound, an end of the first power cable connected to the service drone, a power source connected to the first power cable and the second power cable to provide power to the power drone and to the service drone via the first power cable and the second power cable.

In some aspects, the techniques described herein relate to a construction system, including: a truck, a drone system housed in a bed of the truck, the drone system including: a power drone operable to perform a construction task; a service drone operable to assist the power drone; a first motorized reel about which a first power cable is wound, an end of the first power cable connected to the power drone; a second motorized reel about which a second power cable is wound, an end of the first power cable connected to the service drone, a power source connected to the first power cable and the second power cable to provide power to the power drone and to the service drone via the first power cable and the second power cable.

In some aspects, the techniques described herein relate to a construction system, including: a truck; and a drone system housed in a bed of the truck, the drone system including: a power drone operable to perform a construction task; a service drone operable to assist the power drone; a first motorized reel about which a first power cable is wound, an end of the first power cable connected to the power drone; a second motorized reel about which a second power cable is wound, an end of the first power cable connected to the service drone, the service drone including a pulley about which at least a portion of the second power cable extends before extending to the power drone, a protective cage or mesh disposed over the service drone or the power drone, and a power source connected to the first power cable and the second power cable to provide power to the power drone and to the service drone via the first power cable and the second power cable.

In some aspects, the techniques described herein relate to a construction system, including: a drone system including: a power drone operable to perform a construction task; a service drone operable to assist the power drone; a first motorized reel about which a first power cable is wound, an end of the first power cable connected to the power drone; a second motorized reel about which a second power cable is wound, an end of the first power cable connected to the service drone, the service drone including a pulley about which at least a portion of the second power cable extends before extending to the power drone, and a power source connected to the first power cable and the second power cable to provide power to the power drone and to the service drone via the first power cable and the second power cable.

In some aspects, the techniques described herein relate to a construction system, including: a drone system including: a power drone operable to perform a construction task; a service drone operable to assist the power drone; a first motorized reel about which a first power cable is wound, an end of the first power cable connected to the power drone; a second motorized reel about which a second power cable is wound, an end of the first power cable connected to the service drone, and a power source connected to the first power cable and the second power cable to provide power to the power drone and to the service drone via the first power cable and the second power cable.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is an example diagram of a system including supply truck, auxiliary truck, remote operator, and several drones wirelessly communicating with each other.

FIG. 2A is an example illustration of a drone with a protective device utilized.

FIG. 2B is another example illustration of a drone equipped with a powered tool changer utilized for switching through a variety of possible tool attachments.

FIG. 3A is an example drone system in operation.

FIG. 3B is another example drone system in operation.

FIG. 4A is another example drone system in operation.

FIG. 4B is another example drone system in operation.

FIG. 5A is an example of the deployment truck(s) including the drone system, supplies for the drones deployed to a project site.

FIG. 5B is an example of the deployment truck(s) including the drone system, supplies for the drones deployed to a first project site and a second project site wherein the drone and deployment truck(s) are wirelessly communicable to a remote operator.

FIG. 5C is an example of the deployment truck(s) including the drone system, supplies for the drones, and assisting crew (e.g., additional personnel) deployed to a project site.

FIG. 6 depicts a block diagram of an example architecture of a service drone(s) including tool interface data in accordance with illustrative examples.

FIG. 7 depicts a block diagram of an example architecture of a power drone(s) including tool interface data in accordance with illustrative examples.

### DETAILED DESCRIPTION

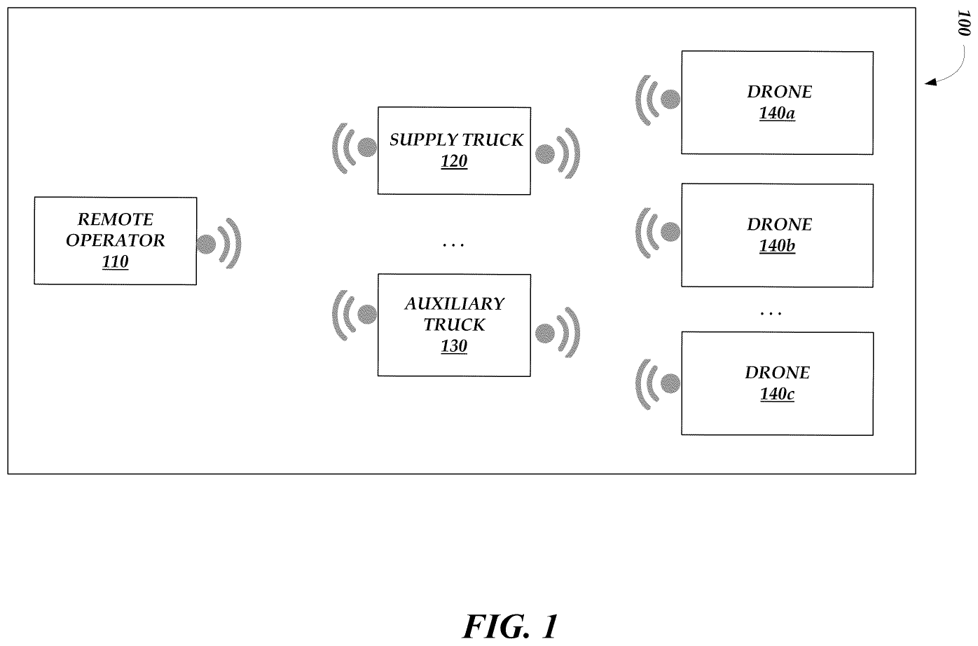

FIG. 1 is a system diagram of an example embodiment of a drone system 100, wherein the drone system includes drone 140a, 140b, and 140c, supply truck 120, auxiliary truck 130, and a remote operator 110. The drone system 100 may easily be deployed in a construction site (also referred to herein as a “project site”) or any other type of development site where the utilization of drone 140a, 140b, and 140c reduces the number of personnel (e.g., construction workers) and large equipment that are required to complete a construction project. The drone 140a, 140b, and 140c illustrated are an example of the various drones 140a, 140b, and 140c that may be used at a project site and not limited to the utilization of three drones. In fact, the drone 140a, 140b, and 140c depicted are a mere representation of a set of drones that may be used at the project site and can further be scaled up to include additional drones not illustrated in FIG. 1. The drone system 100 can have at least two drones (e.g., have only two drones, in one example). For example, the drone system 100 can have a service drone and a power drone, where the power drone is the drone that completes a construction task and the service drone services or assists the power drone. With respect to any of the embodiments described below, which may illustrate the use of multiple service drones and/or multiple power drones, one of skill in the art will recognize that such embodiments can likewise apply to a drone system 100 that only has two drones—one service drone and one power drone.

The supply truck 120 as illustrated, is an example of the various supply trucks 120 that may be used at a project site. In fact, the supply truck 120 is a mere representation of a set of supply trucks 120 that may be used at the project site not illustrated in FIG. 1. Furthermore, the auxiliary truck 130 is an example of the various auxiliary trucks 130 that may be used at a project site. As such, the auxiliary truck 130 depicted is a mere representation of a set of auxiliary truck 130 that may be used at the project not illustrated in FIG. 1.

The drone 140a, 140b, and 140c, may represent the different types of drones used for a project site (e.g. service drones and power drones, further described below) for one or more tasks of a construction job. The drones 140a, 140b, and 140c can advantageously work in unison with one another to perform a construction task. The drones 140a, 140b, and 140c are transported to the project site by the supply truck 120. The supply truck 120 may host or house the desired number of drones 140a, 140b, and 140c for the project, and the drone 140a, 140b, and 140c can be tethered to the supply truck as discussed further below. The supply truck 120 may further include supplies required to complete a project (e.g., tools, materials).

The drones 140a, 140b, and 140c can advantageously exclude battery packs and instead be tethered by a power cord attached to the supply truck 120, so that the supply truck 120 powers the drone 140a, 140b, and 140c during operation of constructions tasks. Advantageously, this reduces the weight of the drone 140a, 140b, 140c, allowing it to increase the payload weight it can carry (e.g., as compared to a drone that also carries a battery pack). Additionally, use of power cords instead of battery packs allows the drone 140a, 140b, 140c to remain in the air longer (since the power source or battery on the supply truck 120 is larger than an individual battery pack for a drone and can power the drone for longer periods of time). The drone 140a, 140b, 140c can receive instructions (e.g., wirelessly) from a remote operator 110 located at the project site (e.g., at the supply truck 120) or remote from the project site. The remote operator 110 can send instructions to the drone 140a, 140b, and 140c to execute a specific construction task. Alternatively, the drone 140a, 140b, 140c can operate autonomously. The drone 140a, 140b, and 140c may be deployed with a pre-fixed tool attached to the drone 140a, 140b, and 140c with a sole operation function (e.g., carrying a pulley), or the drone 140a, 140b, and 140c may have a tool attachment that can selectively couple to multiple different tools, as needed, to complete a designated task.

The drone 140a, 140b, and 140c may return to the supply truck 120 to retrieve a material required for a construction task or the drone 140a, 140b, and 140c may return to the supply truck 120 to replace the attached tool to an appropriate tool to complete a specific task (e.g., a subsequent construction task). The drone 140a, 140b, and 140c may be instructed by a remote operator 110 to return for supplies or reconfiguration of the tools attached, or the drone 140a, 140b, and 140c may perform the tasks autonomously. Furthermore, the auxiliary truck 130 may further include building supplies and tool attachments wherein the drone 140a, 140b, and 140c may be able to retrieve building supplies and/or tools from the auxiliary truck 130 in the same fashion as with the supply truck 120. The auxiliary truck 130 may further include additional personnel to assist with the project development as some aspects of the project development may not be accomplished by way of drone 140a, 140b, and 140c. The auxiliary truck 130 can leave the project site once it is empty (e.g., its supplies or materials have been used) and be replaced by another auxiliary truck 130 carrying additional building materials or supplies (e.g., the auxiliary trucks 130 can cycle through the construction site).

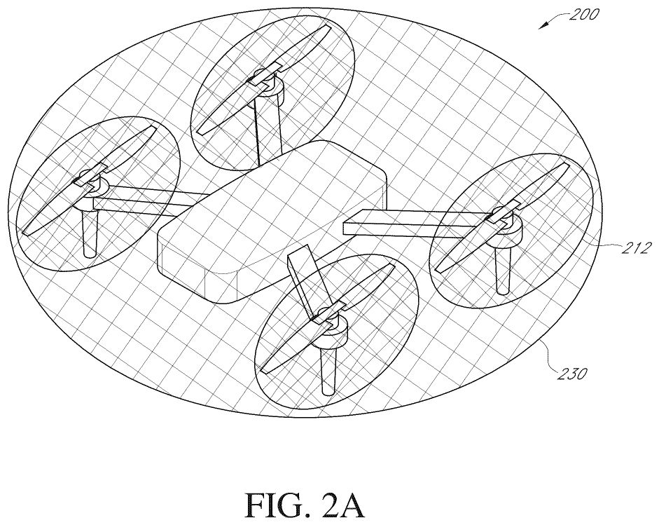

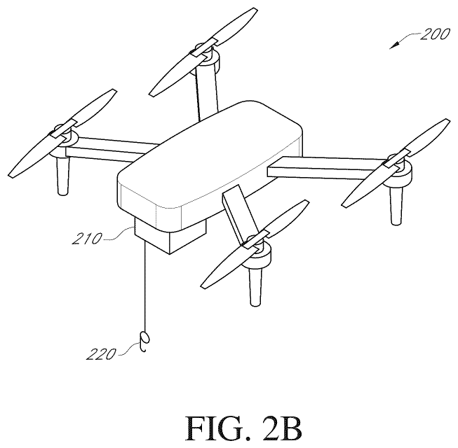

FIG. 2A is an example illustration of a drone 200 that may represent one or more of drone 140a, 140b, and 140c of FIG. 1 or other drones described herein. The drone 200 can include a protection device 230 attached to the drone 200 to prevent the drone 200 (e.g., the propellers of the drone 200) from coming into contact with other obstacles present on a project site (e.g., the power cable that extends from the supply truck 120 to the drone). In one example, the protection device 230 can be a cage or mesh that extends about the entire drone 200. Additionally, or alternatively, the drone 200 can include a halo protection device 212 disposed over each of the propellers of the drone 200 to inhibit (e.g., prevent) the blades of the drone 200 from coming into contact with other obstacles present on a project site.

FIG. 2B is an example embodiment of a drone 200 that may represent one or more of the drone 140a, 140b, and 140c of FIG. 1 or other drones described herein. The drone 200 can include or removably couple to a powered tool changer 210. The powered tool changer 210 is used as an attachment point or coupling mechanism for a desired tool (e.g., power tool) to not only mechanically couple to the drone 200 but to also supply electrical power to said tool to energize the tool (e.g., to power the tool). A non-limiting example of the attachable tools include a pile driver, a winch, a power screwdriver (e.g., screwdriver with automatic loader), a nail gun, a drill, grabbers, hooks, and the like. The example embodiment as depicted includes a hook 220 via which the drone 200 can lift or carry one or more objects. This illustrated example is merely a representation of an example embodiment and should not be limited to the features as illustrated.

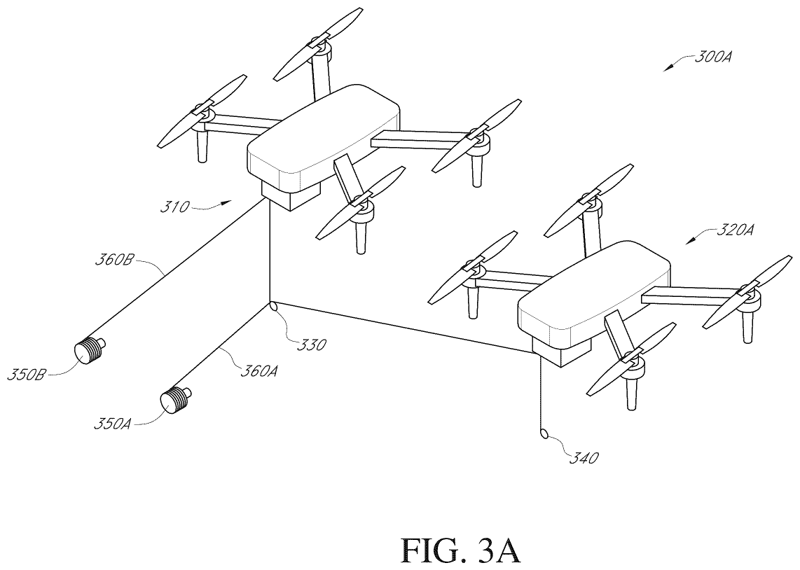

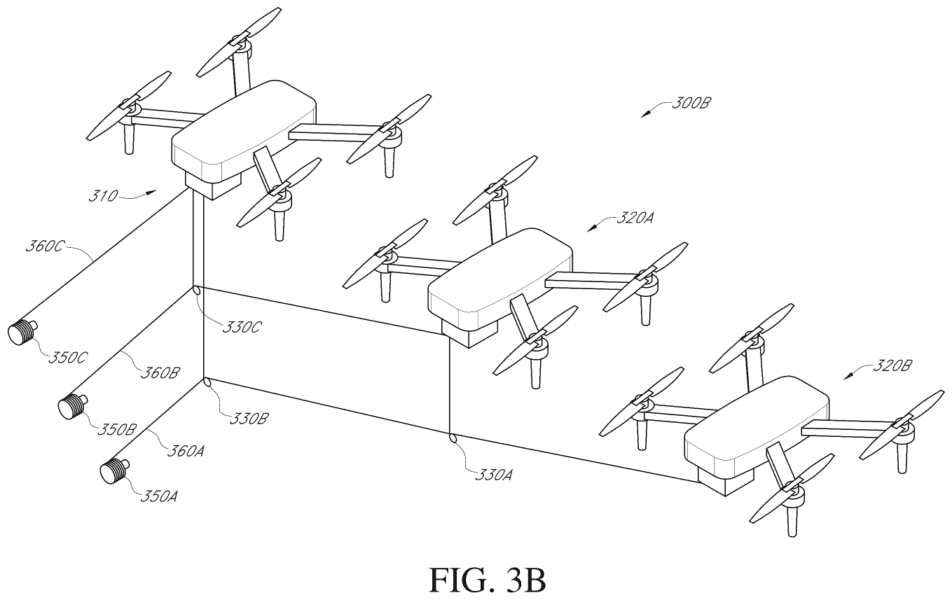

FIG. 3A is an example illustration of an embodiment of the drone system 300A, wherein the drone system 300A includes a power drone 320A and a service drone 310 working in unison to complete a designated task (e.g., a designated construction task at the project site). The example embodiment depicts a power drone 320A connected (e.g., tethered) to a first cable 360A (e.g., a power cable) and a pulley 330 attached to the service drone 310. One end of the first cable 360A is attached to (e.g., wound on) a first motorized reel 350A and the other end is connected (e.g., tethered) to the power drone 320A. The power drone 320A can have a tool 340 for performing a specific task (e.g., a tool coupled via a powered tool changer, such as the power tool changer 210 described above). A second cable 360B (e.g., power cable) can extend from a second motorized reel 350B (e.g., on which it is wound) and be attached to the service drone 310. Advantageously, the power drone 320A and service drone 310 are powered via the first and second cable 360A, 360B, respectively, making it unnecessary for the power drone 320A and service drone 310 to carry batteries, allowing the power drone 320A and service drone 310 to carry more weight (e.g., construction materials, tools) when performing construction tasks in the project site. The service drone 310 carries the pulley 330 about which the cable 360A extends before continuing to the power drone 320A, advantageously preventing the cable 360A from dragging on the ground at the project site, thereby avoiding wear and tear on the cable 360A (and reducing maintenance thereof) and the possibility of the cable 360A becoming entangled or caught in an object of the project site. The service drone 310 works in unison with the power drone 320A to perform the designated construction task.

The first motorized reel 350A and the second motorized reel 350B may be attached to a supply truck (e.g., supply truck 120 in FIG. 1). For example, the first motorized reel 350A and the second motorized reel 350B can be located in the bed of the supply truck. The first motorized reel 350A and the second motorized reel 350B can be operated (e.g., autonomously by the drone system, by a remote operator, etc.) to increase or reduce the length of the first and second cable 360A, 360B that is deployed to the service drone 310 and to the power drone 320A, respectively (e.g. depending on the location where the construction task is to be performed). The drone system 300A may uniformly travel (e.g., the service drone 310 and power drone 320A can travel in unison) to and from a supply truck. Furthermore, the first cable 360A and second cable 360B may be energized providing electricity to the power drone 320A and service drone 310.

FIG. 3B is an example illustration of an embodiment of the drone system 300B, wherein the drone system 300B includes power drone 320A, 320B and service drone 310 working in unison to complete a designated task (e.g., a designated construction task at the project site). The example embodiment depicts a power drone 320B connected (e.g., tethered) to a first cable 360A (e.g., a power cable), which extends at least partially about a first pulley 330A attached to the power drone 320A and further extends at least partially about a second pulley 330B attached to the service drone 310. One end of the first cable 360A is attached to (e.g., wound on) a first motorized reel 350A and the other end is attached to the power drone 320B. The first cable 360A may be energized, providing electricity to the power drone 320B eliminating the need for batteries.

A second cable 360B (e.g., power cable) extends at least partially about a third pulley 330C attached to the service drone 310, one end of the second cable 360B attached to the power drone 320A and the other end of the second cable 360B attached to (e.g., wound on) a second motorized reel 350B, thereby allowing the power drone 320A to be tethered to the second motorized reel 350B. The power drone 320A can work in unison and aid the power drone 320B with the designated task (e.g., a designated construction task at the project site). Furthermore, a third cable 360C is connected (e.g., tethered) to the service drone 310 wherein the other end of the cable is attached to (e.g., wound on) the third motorized reel 350C.

Advantageously, the power drone 320A and 320B, and service drone 310 are powered via the first, second, and third cable 360A, 360B, and 360C, respectively, making it unnecessary for the power drone 320A, 320B and service drone 310 to carry batteries, allowing the power drone 320A, 320B and service drone 310 to carry more weight (e.g., construction materials, tools) when performing construction tasks in the project site. The service drone 310 carries the second and third pulley 330B, 330C via which the first and second cable 360A, 360B, respectively extends to the power drone 320A, 320B, advantageously preventing the first and second cable 360A, 360B from dragging on the ground at the project site, thereby avoiding wear and tear on the first and second cable 360A, 360B (and reducing maintenance thereof) and the possibility of the first and second cable 360A, 360B becoming entangled or caught in an object of the project site. The service drone 310 works in unison with the power drone 320A, 320B to perform the designated construction task. The power drone 320A, 320B can include a tool attachment for performing a specific task on the project site as required.

The first motorized reel 350A, the second motorized reel 350B, and the third motorized reel 350C may be attached to a supply truck (e.g., supply truck 120 in FIG. 1). For example, the first motorized reel 350A, the second motorized reel 350B, and the third motorized reel 350C can be located in the bed of the supply truck. The first motorized reel 350A, the second motorized reel 350B, and the third motorized reel 350C can be operated (e.g., autonomously by the drone system, by a remote operator, etc.) to increase or reduce the length of first, second, and third cable 360A, 360B, and 360C that is deployed to the service drone 310 and to the power drone 320A, 320B, respectively (e.g., depending on the location where the construction task is to be performed). Drone system 300B may uniformly travel (e.g., the service drone 310 and power drone 320A, 320B can travel in unison) to and from a supply truck. Furthermore, the first cable 360A, the second cable 360B, and third cable 360C may be energized providing electricity to the power drone 320A, 320B, and the service drone 310.

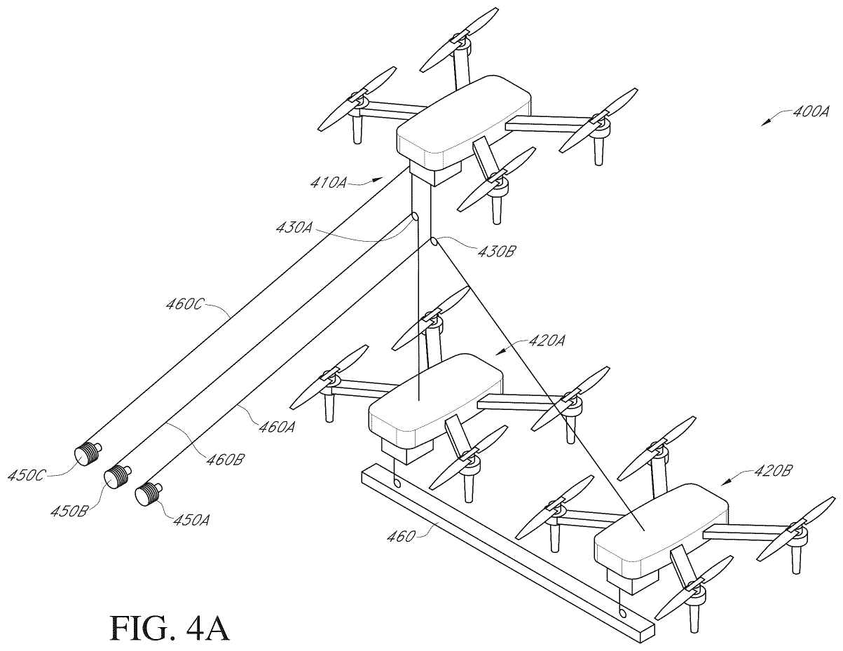

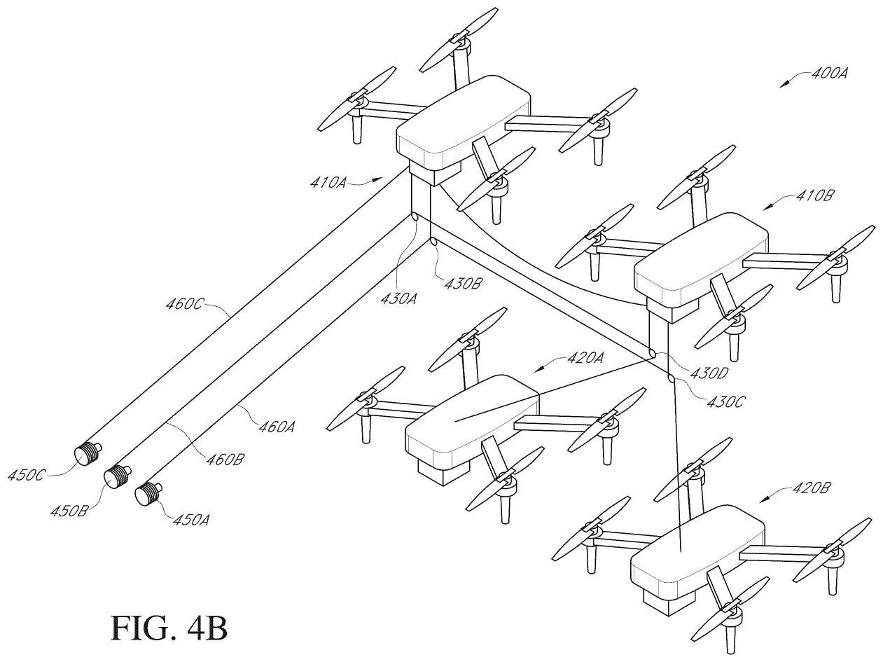

FIG. 4A is an example illustration of an embodiment of the drone system 400A, wherein the drone system 400A includes a first service drone 410A with a second pulley 430B attached with a first cable 460A and a first pulley 430A attached with a second cable 460B. The first cable 460A (e.g., power cable) and the second cable 460B (e.g., power cable) are utilized to support the first power drone 420A and the second power drone 420B as they work in unison to execute the designated work task (e.g., a designated construction task at the project site). In this illustration, the first power drone 420A and second power drone 420B are working in unison to lift a beam 460 to deliver it to a specific location on the project site (e.g., construction site). Attached to the first cable 460A on one end is a first motorized reel 450A (e.g., on which the first cable 460A is wound) and the other end is connected (e.g., tethered) to the second power drone 420B. Attached to the second cable 460B, on one end is a second motorized reel 450B (e.g., on which the first cable 460B is wound) and the other end is connected (e.g., tethered) to the first power drone 420A. The first service drone 410A is connected (e.g., tethered) to a third cable 460C wherein the third cable 460C is attached to (e.g., wound on) a third motorized reel 450C. The first and second motorized reel 450A, 450B, in this example, can be used to help the first power drone 420A and second power drone 420B lift the heavy beam by providing direct power to the first and second power drone 420A, 420B so that the first and second power drone 420A, 420B do not need to carry a battery pack. Doing so reduces the weight of the first and second power drone and increases the amount of weight they can carry. Furthermore, the first and second motorized reels 450A, 450B, can be used to manage the length of the first and second cable 460A, 460B while the drones operate on a project site.

Advantageously, the first and second power drone 420A, 420B and first service drone 410A are powered via the first, second, and third cable 460A, 460B, and 460C making it unnecessary for the first and second power drone 420A, 420B and the first service drone 410A to carry batteries, allowing the first and second power drone 420A, 420B and the first service drone 410A to carry more weight (e.g., construction materials, tools) when performing construction tasks in the project site. The first service drone 410A carries the first and second pulleys 430A, 430B over which the first and second cable 460A, 460B extend and before continuing to the first and second power drone 420A, 420B, advantageously preventing the first and second cable 460A, 460B from dragging on the ground at the project site, thereby avoiding wear and tear on the first and second cable 460A, 460B (and reducing maintenance thereof) and the possibility of the first and second cable 460A, 460B becoming entangled or caught in an object of the project site. The first service drone 410A works in unison with the first and second power drone 420A, 420B to perform the designated construction task.

The first cable 460A, second cable 460B, and the third cable 460C are used to supply the respective drones with electrical power from the supply truck (e.g., supply truck 120 in FIG. 1) to supply the first service drone 410A, first power drone 420A, and second power drone 420B with electrical supply needed to operate. The first cable 460A, second cable 460B, and the third cable 460C attached to (e.g., wound on) the first motorized reel 450A, second motorized reel 450B, and third motorized reel 450C, respectively, which may be attached to a supply truck (e.g., supply truck 120 in FIG. 1). For example, the first motorized reel 450A, second motorized reel 450B, and third motorized reel 450C can be operated (e.g., autonomously by the drone system, by a remote operator, etc.) to increase or reduce the length of the first cable 460A, second cable 460B, and the third cable 460C that is deployed to the first service drone 410A and the first and second power drone 420A, 420B, respectively (e.g. depending on the location where the construction task is to be performed).

FIG. 4B is an example illustration of an embodiment of the drone system 400B, wherein the drone system 400B includes a first service drone 410A and a second service drone 410B wherein both the first service drone 410A and the second service drone 410B are utilized to provide support for a first power drone 420A and a second power drone 420B. The first service drone 410A includes a second pulley 430B, a first pulley 430A, and an attachment point 430E. The attachment point 430E may optionally be a further third pulley. The second service drone 410B includes a fourth pulley 430C and a fifth pulley 430D. A first cable 460A (e.g., power cable) extends at least partially about the fourth pulley 430C and the second pulley 430B. Attached to one end of the first cable 460A is a first motorized reel 450A (e.g., on which the first cable 460A is wound) while the other end is connected (e.g., tethered) to the second power drone 420B wherein the motorized reel 450A is able to provide assistance to the second power drone 420B with a designated task (e.g., a designated construction task at the project site) by supplying power (via the first cable 460A) to the second power drone 420B.

A second cable 460B extends at least partially about a fifth pulley 430D and the first pulley 430A. One end of the second cable 460B is attached to (e.g., wound on) a second motorized reel 450B and the other end is connected (e.g., tethered) to the first power drone 420A, wherein the second motorized reel 450B provides assistance to the first power drone 420A with a designated task (e.g., a designated construction task at the project site) by supplying power (via the second cable 460B) to the first power drone 420A. A third cable 460C is connected (e.g., tethered) to the attachment point 430E of the first service drone 410A wherein one end of the third cable 460C is attached to (e.g., wound on) a third motorized reel 450C and the other end is connected (e.g., tethered) to the second service drone 410B wherein the third motorized reel 450C may provide assistance to the first service drone 410A and second service drone 410B (e.g., by supplying power via the third able 460C to the first service drone 410A and second service drone 410B). The first service drone 410, second service drone 410B, first power drone 420A, and second power drone 420B work in unison with one another to prevent entanglement of any one of the cables being used on a project site.

Advantageously, the first service drone 410A, second service drone 410B, first power drone 420A, and second power drone 420B are powered via the first, second, and third cable 460A, 460B, and 460C, respectively, making it unnecessary for the first service drone 410A, second service drone 410B, first power drone 420A, and second power drone 420B to carry batteries, allowing the first service drone 410A, second service drone 410B, first power drone 420A, and second power drone 420B to carry more weight (e.g., construction materials, tools) when performing construction tasks in the project site. The first service drone 410A and second service drone 410B carry the various pulley systems which the first and second cable 460A, 460B, advantageously preventing the first and second cable 460A, 460B from dragging on the ground at the project site, thereby avoiding wear and tear on the first and second cable 460A, 460B (and reducing maintenance thereof) and the possibility of the first and second cable 460A, 460B becoming entangled or caught in an object of the project site. The first service drone 410A and the second service drone 410B work in unison with the first power drone 420A and second power drone 420B to perform the designated construction task.

The first motorized reel 450A, the second motorized reel 450B, and the third motorized reel 450C may be attached to a supply truck (e.g., supply truck 120 in FIG. 1). For example, the first motorized reel 450A, the second motorized reel 450B, and the third motorized reel 450C can be located in the bed of the supply truck. The first motorized reel 450A, the second motorized reel 450B, and the third motorized reel 450C can be operated (e.g., autonomously by the drone system, by a remote operator, etc.) to increase or reduce the length of first, second, and third cable 460A, 460B, 460C that is deployed to the first service drone 410A, second service drone 410B, first power drone 420A, and second power drone 420B, respectively (e.g. depending on the location where the construction task is to be performed). The drone system 400B may uniformly travel (e.g., the service drone 310 and power drone 320A can travel in unison) to and from a supply truck. Furthermore, the first cable 460A, the second cable 460B, and the third cable 460C may be energized providing electricity to the first service drone 410A, second service drone 410B, first power drone 420A, and second power drone 420B.

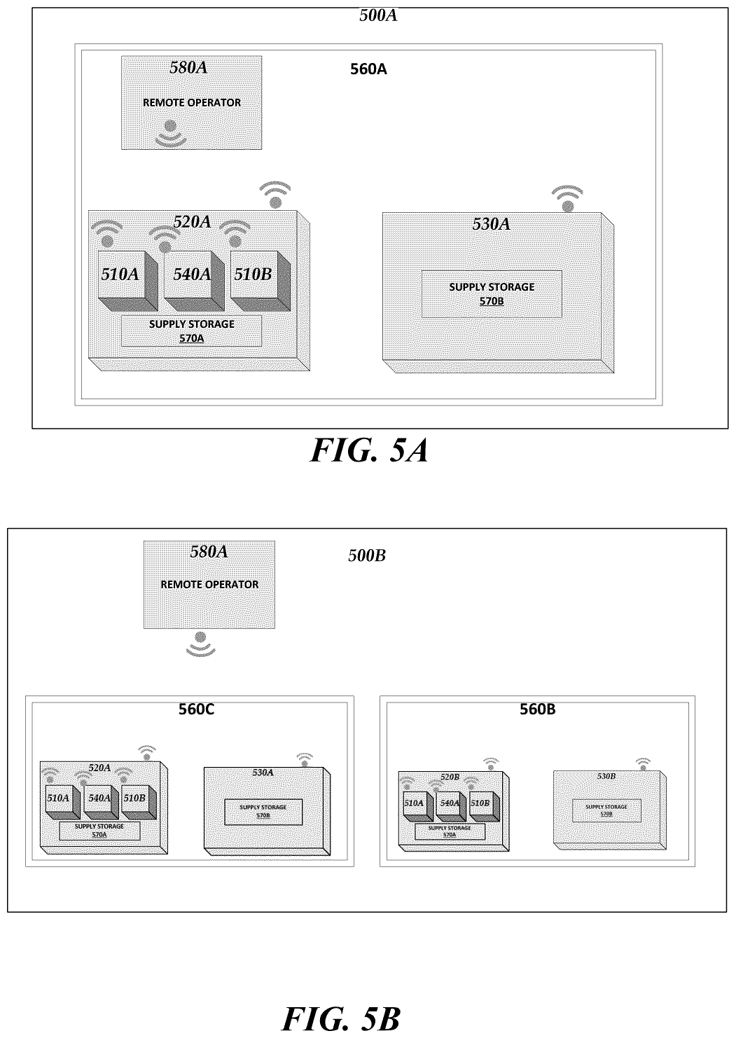

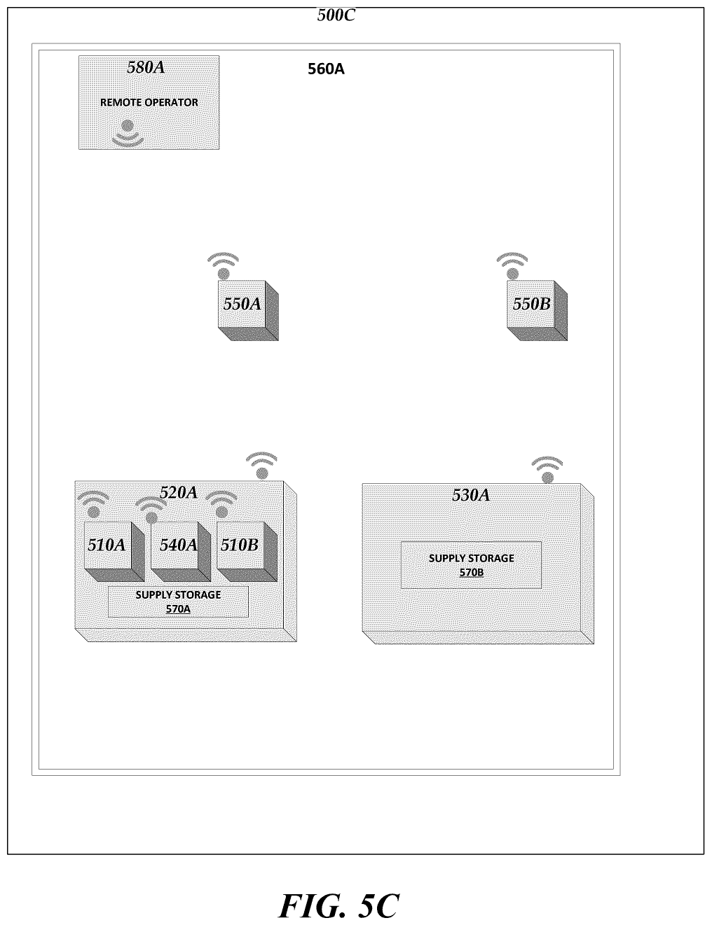

FIG. 5A depicts an embodiment of a drone system 500A deployed on a first project site 560A including a remote operator 580A, a supply truck 520A, and an auxiliary truck 530A. The supply truck 520A can transport a power drone 540A, a first and a second service drone 510A, 510B along with a first set of supplies located in a supply storage 570A required to operate the power drone 540A and the first and second service drone 510A, 510B such as tools, battery packs, and the like. For example, the supply truck 520A can carry battery pack(s) (on the bed of the truck) that are electrically connected to the cables that extend from (e.g., are wound on) the motorized reels on the supply truck 520A to the power drone 540A and the first and second service drone 510A, 510B. The power drone 540A and the first and second service drone 510A, 510B are powered by the battery pack(s) on the supply truck 520A via the cables. The supplies are just an example of the type of supplies that are required for a project on the first project site 560A and not limited to the example of tools and battery packs as described above. The supply truck 520A is used to transport the power drone 540A and the first and second service drone 510A, 510B along with supplies that might be needed for a second project site 560B of FIG. 5B.

The power drone 540A and the first and second service drone 510A, 510B may further indicate to the remote operator 580A that a tool required for use is no longer available as at least one of the power drone 540A and the first and second service drone 510A, 510B may be currently using the specific tool, or a supply indicated for a power drone 540A and the first and second the first and second service drone 510A, 510B to retrieve is running low. The power drone 540A and the first and second service drone 510A, 510B may wirelessly communicate with the remote operator 580A, receiving instruction from the remote operator 580A indicating to change a tool attachment located on the supply truck 520A. Furthermore, the power drone 540A and the first and second service drone 510A, 510B may receive instructions from a remote operator 580A to retrieve a required supply that may be located on an auxiliary truck 530A located in the supply storage 570B. Supply storage 570B can be located on a truck bed or within an enclosed cargo container (e.g., box truck) where the power drone 540A and the first and second service drone 510A, 510B will still have access to the supplies. The power drone 540A and the first and second service drone 510A, 510B may be equipped with sensors that provide information to the power drone 540A and the first and second service drone 510A, 510B to determine if the tool or supply that is required to retrieve from the supply truck 520A and auxiliary truck 530A is located appropriately.

An example of sensors utilized by the power drone 540A and the first and second service drone 510A, 510B may be photo sensors, distance sensors, global positioning sensors (GPS), and the like. The sensors described are just a list of example sensors and not limited to the sensors described previously. The power drone 540A and the first and second service drone 510A, 510B, may further operate autonomously, determining the next tool or supply that may be required to proceed with the ongoing project. The power drone 540A and the first and second service drone 510A, 510B, may be assigned with a specific task to complete wherein the power drone 540A and the first and second service drone 510A, 510B may be operating individually or uniformly to complete the designated task. The power drone 540A and the first and second service drone 510A, 510B may determine individually or uniformly to retrieve a tool or supply from a supply truck 520A or auxiliary truck 530A.

The power drone 540A and the first and second service drone 510A, 510B may further store in memory a location of a specific tool or supply that was delivered to a location on a project site. As the tool or supply is required to complete a task, the power drone 540A and the first and second service drone 510A, 510B may travel to the stored location to retrieve the tool or supply. The power drone 540A and the first and second service drone 510A, 510B may wirelessly communicate with each other relaying location information and item information. Location information may be of the location of the power drone 540A and the first and second service drone 510A, 510B and the item information may be the location of a tool or supply.

FIG. 5B depicts an embodiment of a drone system 500B deployed on a second project site 560B and a third project site 560C including a remote operator 580A, a supply truck 520A and 520B, and an auxiliary truck 530A and 530B deployed at both the second project site 560B and third project site 560C. The supply truck 520A and 520B can transport the power drone 540A and the first and second service drone 510A, 510B along with a first set of supplies located in the supply storage 570A required to operate the power drone 540A and the first and second service drone 510A, 510B such as tools, battery packs, and the like. The supplies are just an example of the type of supplies that are required for a project on the second project site 560B and third project site 560C and not limited to the example of tools and battery packs as described above. The supply truck 520A and 520B is used to transport the power drone 540A and the first and second service drone 510A, 510B along with supplies that might be needed for a second project site 560B and third project site 560C wherein the supply trucks 520A and 520B may travel between the second project site 560B and third project site 560C. The remote operator 580A can advantageously control the first and second service drones 510A, 510B and power drone 540A at the second project site 560B and also control (e.g. simultaneously) the first and second service drones 510A, 510B and power drone 540A at the third project site 560C, thereby controlling (e.g., simultaneously) multiple drone systems.

The power drone 540A and the first and second service drone 510A, 510B may receive instructions from a remote operator 580A to retrieve a required supply that may be located on a supply truck 520A, located in the second project site 560B. The power drone 540A and the first and second service drone 510A, 510B may determine, by processing memory data, that the required supply is in fact not located on the supply truck 520A, an indication may be sent to the remote operator 580A indicating the required supply is located supply truck 520B from the third project site 560C. The remote operator 580A may command the power drone 540A and the first and second service drone 510A, 510B to retrieve the tool from the supply truck 520B from the third project site 560C. Furthermore, the power drone 540A and the first and second service drone 510A, 510B may autonomously determine to retrieve the required supply from the supply truck 520B from the third project site 560C based on a request to retrieve a required supply. The power drone 540A and the first and second service drone 510A, 510B may wirelessly communicate with the remote operator 580A receiving instruction from the remote operator 580A indicating a required supply or a tool attachment is location.

Furthermore, the power drone 540A and the first and second service drone 510A, 510B may receive instructions from a remote operator 580A to retrieve a required supply that may be located on an auxiliary truck 530A in the second project site 560B in the supply storage 570B or an auxiliary truck 530B in the third project site 560C in the supply storage 570B. The power drone 540A and the first and second service drone 510A, 510B may be equipped with sensors that may provide information to the power drone 540A and the first and second service drone 510A, 510B to determine if the tool or supply that is required to retrieve from the supply truck 520A and 520B and auxiliary truck 530A and 530B.

An example of sensors utilized by the power drone 540A and the first and second service drone 510A, 510B may be photo sensors, distance sensors, global positioning sensors (GPS), and the like. The sensors described are just a list of example sensors and not limited to the sensors as described previously. The power drone 540A and the first and second service drone 510A, 510B, may further operate autonomously, determining the next tool or supply that may be required to proceed with the ongoing project with respect to the second project site 560B and third project site 560C. The power drone 540A and the first and second service drone 510A, 510B, may be assigned with a specific task to complete wherein the power drone 540A and the first and second service drone 510A, 510B may be operating individually or uniformly to complete the designated task. The power drone 540A and the first and second service drone 510A, 510B, may be assigned with a specific task to complete across the second project site 560B and third project site 560C wherein the power drone 540A and the first and second service drone 510A, 510B may be operating individually or uniformly to complete the designated task with respect to the second project site 560B and third project site 560C. The power drone 540A and the first and second service drone 510A, 510B may determine individually or uniformly to retrieve a tool or supply from a supply truck 520A and 520B or auxiliary truck 530A and 530B based on availability and accessibility to the second project site 560B and third project site 560C.

The power drone 540A and the first and second service drone 510A, 510B may further store in memory a location of a specific tool or supply that was delivered to a location on a second project site 560B or a third project site 560C. A power drone 540A and the first and second service drone 510A, 510B may determine the location of the tool or supply where the power drone 540A and the first and second service drone 510A, 510B may need to travel to retrieve said tool or supply as required. The power drone 540A and the first and second service drone 510A, 510B may wirelessly communicate with each other relaying location information and item information wherein the location information may be of the location of the power drone 540A and the first and second service drone 510A, 510B and the item information may be the location of a tool or supply based on a finite location in a second project site 560B and third project site 560C where the power drone 540A and the first and second service drone 510A, 510B delivered the tool to or drone is currently using.

FIG. 5C depicts an embodiment of a drone system 500C deployed on a first project site 560A including a remote operator 580A, a supply truck 520A, a first construction crew 550A, a second construction crew 550B, and an auxiliary truck 530A deployed in the first project site 560A. The supply truck 520A is used to transport the power drone 540A and the first and second service drone 510A, 510B along with a first set of supplies stored in the supply storage 570A (e.g., such as tools, battery packs, etc.) required to operate the power drone 540A and the first and second service drone 510A, 510B. The supplies are just an example of the type of supplies that are required for a project on the first project site 560A and not limited to the example of supplies as described previously. The auxiliary truck 530A is used to transport additional supplies stored in a supply storage 570B (e.g., truck bed) to the first project site 560A where the power drone 540A and the first and second service drone 510A, 510B are able to retrieve required tools or material from the supply storage 570B.

The power drone 540A and the first and second service drone 510A, 510B may be operable to assist a construction crew 550A and 550B that are working on the first project site 560A. The construction crew 550A and 550B may be utilized on a first project site 560A for development of a project with assistance from the power drone 540A and the first and second service drone 510A, 510B working autonomously, receiving instruction by the remote operator 580A, or receiving instruction by a construction crew 550A and 550B. An example of a first project site 560A might be a construction project that may include the development of single-family homes, multi-family homes, commercial style properties that include high rise buildings or warehouses, and the like. The power drone 540A and the first and second service drone 510A, 510B may be utilized for assisting the construction crew 550A by tool and/or supply delivery to the designated location. The power drone 540A and the first and second service drone 510A, 510B may determine to deliver the tool and/or supply autonomously, instructions received by the remote operator 580A, or instructions received by construction crew 550A and 550B. The construction crew 550A and 550B may submit instruction to the power drone 540A and the first and second service drone 510A, 510B via a wireless earpiece that hosts a microphone and speaker system, equipped with features to enable wireless communication with the power drone 540A and the first and second service drone 510A, 510B or other members of the construction crew 550A and 550B.

The construction crew 550A and 550B may determine a tool is required to complete a designated task and instruct the power drone 540A and the first and second service drone 510A, 510B to retrieve the required tool. The power drone 540A and the first and second service drone 510A, 510B may determine, from processing memory data, the location of where the tool was last delivered to and retrieve the tool from the previous delivered location. Furthermore, the power drone 540A and the first and second service drone 510A, 510B may perform a search of the first project site 560A if the required tool cannot be located. In some implementations, the drone(s) (e.g., the power drone 540A and first and second service drone 510A, 510B) can use a large language model (LLM) and visual capabilities (e.g., cameras) to locate tools and/or material in the construction site. For example, a remote operator 580A operator or the construction crew 550A and 550B can give instructions or commands to the drones in natural language and the drones can visually locate the requested tools and/or material to bring to the construction crew 550A and 550B.

The power drone 540A and the first and second service drone 510A, 510B may determine the next steps of the project development and autonomously navigate to the supply truck 520A or auxiliary truck 530A to pick up the designated tool or supply while transporting the tool or supply back to the construction crew 550A and 550B.

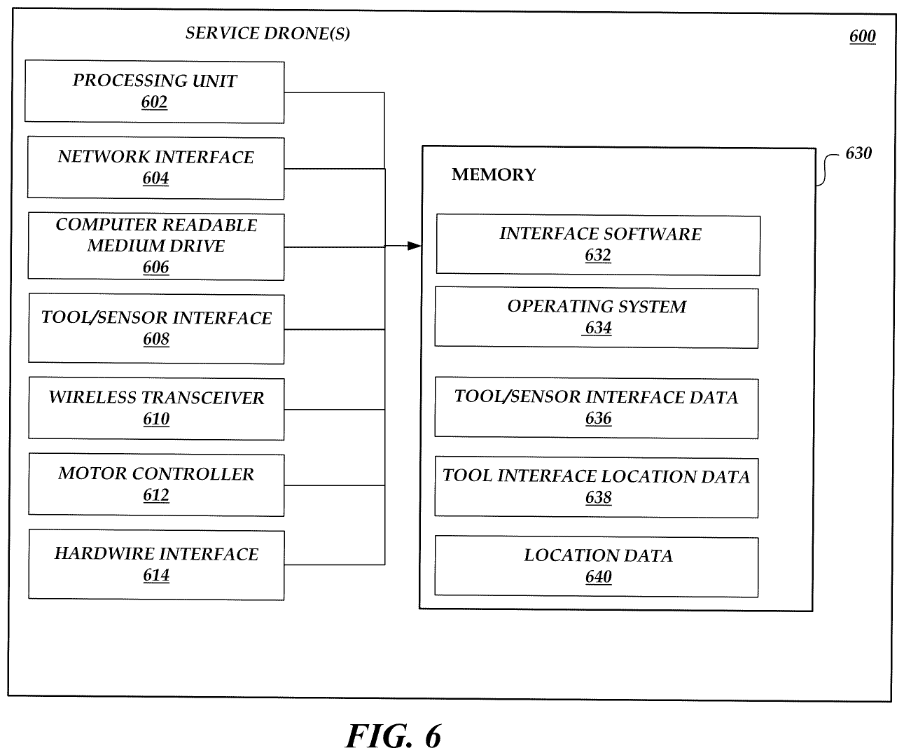

FIG. 6 depicts a block diagram of an example architecture of a service drone 600 with autonomous and controllable flight navigation and project development. The general architecture of the service drone 600 represents all the features with respect to any of the service drones described in all the figures presented, including hardware and software components that may be used to implement the aspects of service drone 600. As illustrated, the service drone 600 includes a processing unit 602, a network interface 604, a computer readable medium drive 606, a tool/sensor interface 608, a wireless transceiver 610, a motor controller 612, hardwire interface 614, and a memory 630. The processing unit 602 may receive instructions from memory 630 to find the new requested tool attachment, the service drone 600 may determine and attach the tool based on tool/sensor interface 608.

The tool/sensor interface 608 may capture sensor data with respect to location of a tool or supply the service drone 600 may be instructed to look for. The service drone 600 can capture the sensor data and make a determination of tool or supply location. The service drone 600 may further transmit live video data via wireless transceiver 610 to a remote operator for visual inspection by the remote operator with regards to tool and supply location. The service drone 600 may determine the location of a tool or supply and store the information in the tool interface location data 638 wherein the tool interface location data 638 may be transmitted to other service drones or power drones on the project site, furthermore the tool interface location data 638 may be transmitted to a remote operator.

The service drone 600 may further determine from the tool/sensor interface a global positioning location of the service drone 600 and store the data as location data 640 in memory 630 and wirelessly transmit the location data to other service drone, power drones, or remote operators. The service drone 600 may further receive location information of other service drones or power drones for avoidance of collision and uniform task execution when required. The processing unit 602 may further determine based on location data 640 the instruction that should be sent to the motor controller 612 in which the motor controller 612 can control the flight path and elevation of the service drone 600. The processing unit 602 may further determine based on a load the service drone is carrying to increase output of motors of the drone by way of the motor controllers 612.

The service drone 600 may be connected to a supply truck to obtain power requirements for flight and project operations via the hardwire interface 616. The hardwire interface may be connected to cables where power is being distributed by a supply truck.

Furthermore, the service drone 600 may operate as a supporting system to a power drone 320A of FIG. 3A, the service drone 600 may be equipped with a pulley like attachment where a power drone 320A of FIG. 3A may utilize the lifting capabilities of the power drone 320A of FIG. 3A and the service drone 600. The configuration is not limited to the use of one service drone 600 or one power drone 320A of FIG. 3A, in fact the system may be scaled up or scaled down the number of service drone 600 or power drone 320A of FIG. 3A as required.

The network interface 604 can provide connectivity of the service drone 600 to a network within a local area to enable communication with other service drone, power drone, and remote operators. The processing unit 602 can also communicate to and from memory 630.

The information can be communicated to the processing unit 602 for processing tool or supply pick up and/or delivery or project execution with uniform movement and development with other service drone or power drone on the project site. The tool/sensor interface 608 may further enable sensor data acquisition of the various sensors on the service drone 600.

Memory 630 can correspond to a non-transitory computer-readable medium that includes computer program instructions that the processing unit 602 executes in order to implement supply pick up and/or delivery or project execution with uniform movement and development with other service drone or power drone on the project site. Memory 630 generally includes RAM, ROM, or other persistent or non-transitory memory. Memory 630 can store an operating system 634 that provides computer program instructions for use by the processing unit 602. Memory 630 can further include computer program instructions and other information for implementing aspects of the service drone 600. For example, the memory 630 tool/sensor interface data 636, tool interface location data 638, and location data 640.

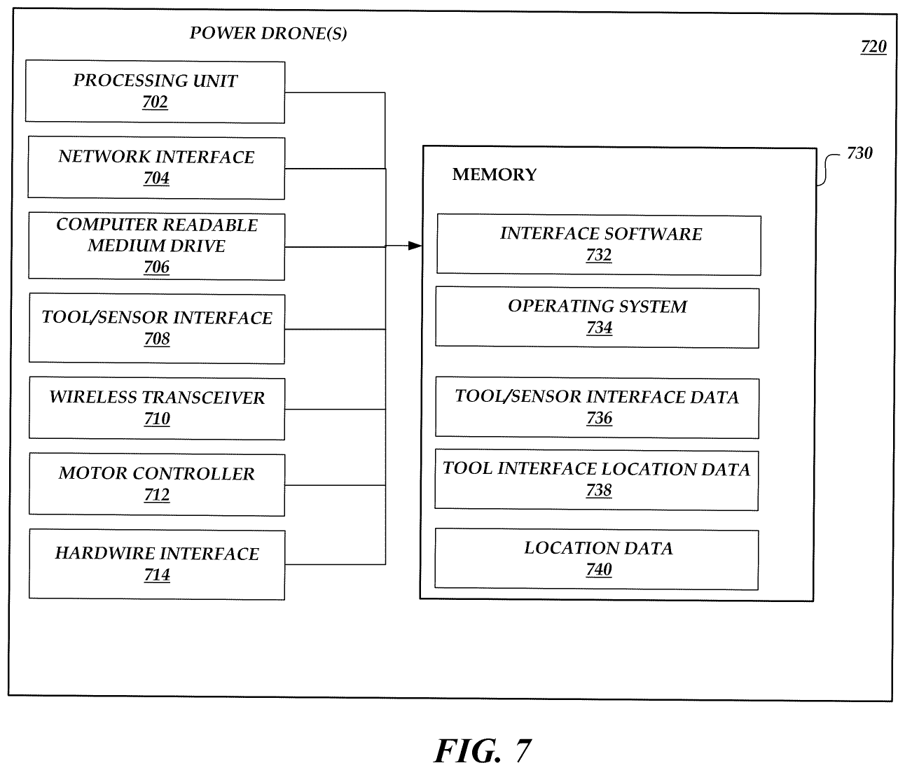

FIG. 7 depicts a block diagram of an example architecture of a power drone 720 with autonomous and controllable flight navigation and project development. The general architecture of the power drone 720 represents all the features with respect to any of the service drones described in all the figures presented, including hardware and software components that may be used to implement the aspects of the power drone 720. As illustrated, the power drone 720 includes a processing unit 702, a network interface 704, a computer readable medium drive 706, a tool/sensor interface 708, a wireless transceiver 710, a motor controller 712, hardwire interface 714, and a memory 730. The processing unit 702 may receive instructions from memory 730 to find the new requested tool attachment, the power drone 720 may determine and attach the tool based on tool/sensor interface 708.

The tool/sensor interface 708 may capture sensor data with respect to location of a tool or supply the power drone 720 may be instructed to look for. The power drone 720 can capture the sensor data and make a determination of tool or supply location. The power drone 720 may further transmit live video data via wireless transceiver 710 to a remote operator for visual inspection by the remote operator with regards to tool and supply location. The power drone 720 may determine the location of a tool or supply and store the information in the tool interface location data 738 wherein the tool interface location data 738 may be transmitted to other service drones or power drones on the project site, furthermore the tool interface location data 738 may be transmitted to a remote operator.

The power drone 720 may further determine from the tool/sensor interface a global positioning location of the power drone 720 and store the data as location data 740 in memory 730 and wirelessly transmit the location data to other service drone, power drones, or remote operators. The power drone 720 may further receive location information of other service drones or power drones for avoidance of collision and uniform task execution when required. The processing unit 702 may further determine based on location data 740 the instruction that should be sent to the motor controller 712 in which the motor controller 712 can control the flight path and elevation of the power drone 720. The processing unit 702 may further determine based on a load the service drone is carrying to increase output of motors of the drone by way of the motor controllers 712.

The power drone 720 may be connected to a supply truck to obtain power requirements for flight and project operations via the hardwire interface 714. The hardwire interface may be connected to cables where power is being distributed by a supply truck.

The network interface 704 can provide connectivity of the power drone 720 to a network within a local area to enable communication with other service drone), power drone, and remote operators. The processing unit 702 can also communicate to and from memory 730.

The information can be communicated to the processing unit 702 for processing tool or supply pick up and/or delivery or project execution with uniform movement and development with other service drone or power drone on the project site. The tool/sensor interface 708 may further enable sensor data acquisition of the various sensors on the power drone 720.

Memory 730 can correspond to a non-transitory computer-readable medium that includes computer program instructions that the processing unit 702 executes in order to implement supply pick up and/or delivery or project execution with uniform movement and development with other service drone or power drone on the project site. Memory 730 generally includes RAM, ROM, or other persistent or non-transitory memory. Memory 730 can store an operating system 734 that provides computer program instructions for use by the processing unit 702. Memory 730 can further include computer program instructions and other information for implementing aspects of the power drone 720. For example, the memory 730 tool/sensor interface data 736, tool interface location data 738, and location data 740.

The advantages of the drone system as described above may include, but is not limited to, full development of a building/project without the need of a building crew or the partial development of a building/project with minimal use of a building crew. The drone system may be fully operable with a remote operator that receives live video feed of the project and may fully complete the project with the use of only one remote operator. Additionally, or alternatively, the drone system may be deployed in any desired location for the development of any type of desired project, the drone system can further be used as a drone delivery system where the drone delivers a tool or supply to a desired location for a second drone or a building crew to use. Furthermore, the drone systems can eliminate the use of large cranes and heavy trucks that are expensive to operate by utilizing the multiple drones to working in unison to lift heavy materials and operate without entanglement of cables that may be used during the process. The use of the drone system for the development of a building/project has additional benefits that further remove personnel from a work (e.g., construction) site, reducing risk of injury as there will be a reduced number of personnel on a building/project site.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of the stated amount. As another example, in certain embodiments, the terms “generally parallel” and “substantially parallel” refer to a value, amount, or characteristic that departs from exactly parallel by less than or equal to 15 degrees.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects, and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or conducted in a manner that achieves or optimizes one advantage or a group of advantages as taught herein without necessarily achieving other objects or advantages as may be taught or suggested herein. In addition, while a number of variations of the invention have been shown and described in detail, other modifications, and methods of use, which are within the scope of this invention, will be readily apparent to those of skill in the art based upon this disclosure. It is contemplated that various combinations or sub combinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A construction system, comprising:
a truck; and
a drone system housed in a bed of the truck, the drone system comprising:
a power drone operable to perform a construction task;
a service drone operable to assist the power drone;
a first motorized reel about which a first power cable is wound, an end of the first power cable connected to the power drone;
a second motorized reel about which a second power cable is wound, an end of the first power cable connected to the service drone, the service drone including a pulley about which at least a portion of the second power cable extends before extending to the power drone,
a protective cage or mesh disposed over the service drone or the power drone, and
a power source connected to the first power cable and the second power cable to provide power to the power drone and to the service drone via the first power cable and the second power cable.

2. The system of claim 1, wherein the power drone includes a powered tool changer.

3. The system of claim 1, further comprising a protective cage or mesh disposed over each propeller of the service drone or power drone.

4. The system of claim 1, wherein the power drone is two power drones.

5. The system of claim 4, wherein the service drone is two service drones.

6. The system of claim 1, wherein the drone system autonomously performs one or more construction tasks to build a building.

7. The system of claim 1, wherein the drone system is configured to assist a construction crew at a construction site.

8. A construction system, comprising:
a drone system comprising:
a power drone operable to perform a construction task;
a service drone operable to assist the power drone;
a first motorized reel about which a first power cable is wound, an end of the first power cable connected to the power drone;
a second motorized reel about which a second power cable is wound, an end of the first power cable connected to the service drone, the service drone including a pulley about which at least a portion of the second power cable extends before extending to the power drone, and
a power source connected to the first power cable and the second power cable to provide power to the power drone and to the service drone via the first power cable and the second power cable.

9. The system of claim 8, wherein the power drone includes a powered tool changer.

10. The system of claim 8, further comprising a protective cage or mesh disposed over each propeller of the service drone or power drone.

11. The system of claim 8, wherein the power drone is two power drones.

12. The system of claim 11, wherein the service drone is two service drones.

13. The system of claim 8, wherein the drone system autonomously performs one or more construction tasks to build a building.

14. The system of claim 8, wherein the drone system is configured to assist a construction crew at a construction site.

15. A construction system, comprising:
a drone system comprising:
a power drone operable to perform a construction task;
a service drone operable to assist the power drone;
a first motorized reel about which a first power cable is wound, an end of the first power cable connected to the power drone;
a second motorized reel about which a second power cable is wound, an end of the first power cable connected to the service drone, and
a power source connected to the first power cable and the second power cable to provide power to the power drone and to the service drone via the first power cable and the second power cable.

16. The system of claim 15, wherein the power drone includes a powered tool changer.

17. The system of claim 15, wherein the power drone is two power drones.

18. The system of claim 17, wherein the service drone is two service drones.

19. The system of claim 15, wherein the drone system autonomously performs one or more construction tasks to build a building.

20. The system of claim 15, wherein the drone system is configured to assist a construction crew at a construction site.
